(19) United States
(12) Patent Application Publication
(10) Pub. No.: US 2003/0179095 A1
(43) Pub. Date: Sep. 25, 2003

(54) Method and apparatus for testing a fire detecting device

(76) Inventor: Daniel Opitz, Erkelenz (DE)

Correspondence Address: CLARK & BRODY, Suite 600, 1750 K Street, NW, Washington, DC, 20006, US

(21) Appl. No.: 10/361,825

(22) Filed: Feb. 11, 2003

(30) Foreign Application Priority Data
Feb. 18, 2002 (DE) 102 06 871 2-34

(51) Int. Cl. G08B 17/12

(52) U.S. Cl. 340/578; 382/181; 73/1.01

(57) ABSTRACT

A method for testing a fire sensing system detecting fires in closed spaces on the basis of the pictures of an electro-optic camera comprises the following procedural stages:

determining the characteristic parameters of the electro-optical camera,

determining characteristic parameters of a test chamber,

selecting the characteristic parameters of a test fire,

simulating the state of the test fire in the test chamber on the basis of the test-space parameters and the test-fire parameters,

replicating a picture of the electro-optical camera on the basis of the camera parameters and the simulated state of the test fire, and

feeding the replicated picture to the fire sensing system for fire analysis.

The invention also relates to apparatus with which to implement said method.

The present invention relates to a method for testing a fire detecting device, hereafter fire sensing system, which detects fires in enclosed spaces using an electro-optical recording device, hereafter camera. The invention also relates to apparatus with which to carry out said method.

Fire aboard an aircraft is one of the most dangerous conditions that may arise in flight. If a fire alarm goes off in the cargo space, the pilot must at once activate fire suppressing systems and as called for prepare for emergency landing.

Heretofore fire has been detected on account of the generated smoke and using threshold means such as photoelectric detectors or ionization detectors. Photoelectric detectors operate on the scattering principle whereas ionization detectors contain a radioactive material that in the presence of smoke induces a change of current in the instrument and thereby triggers an alarm. However frequent false alarms are common to both designs. Ratios up to 200/1 of false to genuine alarms have been reported. While such a high false-alarm rate might still be tolerable on the ground or near home, nevertheless it intolerable on account of the high costs and the great danger relating to using fire suppression systems in an aircraft cargo space or to emergency landings.

Therefore proposals already have been advanced (T. Wittkopf, C. Hecker, D. Opitz, The Cargo Fire Monitoring System [CFMS] for the visualization of fire events in aircraft cargo holds, Proceedings of AUBE 2001, 12^{th} International Conference on Automatic Fire Detection, NIST, Gaithersburg, Md. USA, Mar. 25-28, 2001; Das Largo Fire Monitoring System [CFMS], Tü vol. 42 [2001]) to implement fire detection in an aircraft cargo space using a video-based fire detection system. By means of such a fire detection system, a video camera takes a picture of the cargo space and reproduces it in digitized form. The digital camera picture is compared with a previously stored reference picture showing the cargo space free of fire or smoke. Illustratively the average of the gray values of all pixels may be used for analysis and the standard deviations of the gray values may be computed and be used to determined whether fire did break out in the cargo space.

However comprehensive trials are required to test and refine the operational analytical algorithms. For that purpose aircraft cargo spaces are reconstructed, various test fires are set in controlled manner, their pictures are taken by a camera and fed to an analyzer. However such trials entail much complexity and high costs.

The present invention begins at this state of the art. As characterized in its claims, the present invention's purpose is to avoid the drawbacks of known test procedures and in particular to create a simple and economical method for testing a fire sensing system which detects fires in enclosed spaces on the basis of the pictures taken by an electro-optical camera. This problem is solved by the invention by means of a method defined in claim 1 and by the apparatus defined in claim 8. Advantageous implementations of the invention are defined in the dependent claims.

A method of the invention of the initially cited kind comprises the following procedural stages:

determining the characteristic parameters of the electro-optical camera,

determining the characteristic parameters of a test chamber,

determining the characteristic parameters of a test fire,

simulating the state of a test fire in the test chamber on the basis of the test-chamber parameters and the test-fire parameters,

simulating an electro-optical camera picture on the basis of the camera parameters and the simulated state of the test fire, and

feeding the simulated picture to the fire sensing system for fire analysis.

Accordingly the invention is based on the concept to feed a simulated picture instead of a real-fire picture in a real space to the fire sensing system, said simulated picture being generated from a simulated fire. To simulate such a picture, use is made of the characteristic camera parameters, the parameters of the test chamber and of the test fire, and as a result the synthetic pictures allow realistically testing the algorithms used for fire detection. Actual testing spaces need not be built to a significant extent. This feature allows reducing the number of field tests and thereby offers intrinsic, considerable savings.

In a preferred implementation of the method of the present invention, the characteristic parameters of the electro-optical camera are the sensitivity and/or the resolving power of the electro-optical camera. The electric signals transmitted to the fire sensing system then substantially correspond to the monitoring cameras used under actual conditions.

Appropriately, in the method of the present invention, the characteristic parameters of the test chamber are the geometric structure of the test chamber and/or the loading of the test chamber with objects and/or the kind and position of illumination devices. The geometric structure of the test space includes the configuration and size of the outer walls, floor and ceiling. The properties of the surfaces of the test chamber and of the objects therein, in particular their reflectiivities, may also be taken into account. Again the camera position in the test chamber is advantageously specified. In order to realistically simulate the conditions in an aircraft cargo space, the test chambers may be loaded furthermore with objects such as containers or other freight articles that might restrict the camera's field of view.

Again illuminating devices of defined brightness and spectral characteristics may be configured and simulated in the test chamber. Preferably as regards the above discussion, the characteristic parameters of the test fire shall be the kind of fire and/or the burning material and/or the magnitude of the released heat of combustion and/or the kind of generated smoke. Appropriately the kind of fire is selected according to the European standard EN-54. Therein, illustratively, a test fire TF2 denotes a smoldering fire during which wood burns without generating significant heat while producing a light-colored, visible smoke. A test fire TF4 denotes polyurethane foam burning with an open flame and producing large quantities of dark smoke.

In a preferred development of the method of the present invention, the state of the test fire is simulated using a procedure of digital flow simulation. Such simulation procedures for instance include the so-called direct digital simulation (DDS) whereby the Navier-Stokes equations are solved taking into account all magnitudes of the flow. However as regards the present application, the procedure of Large Eddy Spatial Simulation (LES) is preferred, which uses spatial averaging or filtering for the Navier-Stokes equations, and the effect of turbulent fluctuations—of which the magnitudes are less than pre-selected grid dimensions—on the remainder of the flow is taken into account using a turbulence model.

In one appropriate implementation of the method of the invention, the electro-optical camera is a video camera, a camera picture from said video camera being subsequently replicated by a visualization procedure. Various rendering procedures known per se may be used, for instance flat shading, Gouraud or Phong shading, Raytracing or Radiosity. In the present discussion, Raytracing was found especially appropriate because offering photo-realistic pictures with shadows, light refraction, also diffraction and reflection at the test chamber walls of the objects and smoke particles in said chamber.

In a preferred implementation of the method of the invention, the stages of simulating the state of the test fire, the replication of a picture of the electro-optical camera and the transmission of the replicated picture to the fire sensing system are continuously repeated in time in order to feed the test fire as a function of time to the fire sensing system for purposes of fire analysis.

Lastly further data acquisition devices such as temperature sensors may ensue and be used for fire analysis.

The invention also includes apparatus to carry out the above method, said apparatus comprising:

means determining the characteristic parameters of the electro-optical camera,

means to ascertain characteristic parameters pertaining to a test chamber and a test fire,

a simulation device to simulate the state of a test fire in the test chamber based on the test chamber parameters and the test fire parameters,

a replication device to replicate an electro-optical camera picture based on the camera parameters and the simulated state of the test fire, and

means feeding the replicated picture to the fire sensing apparatus for purposes of fire analysis.

Preferably the simulation system and the replication device are integrated into a computer unit.

Further advantageous designs, features and details of the present invention are defined in the dependent claims, the description of the illustrative implementation and the drawings.

The invention is elucidated below in relation to an illustrative implementation and with reference to the drawings. Only those elements essential to describe the invention are shown.

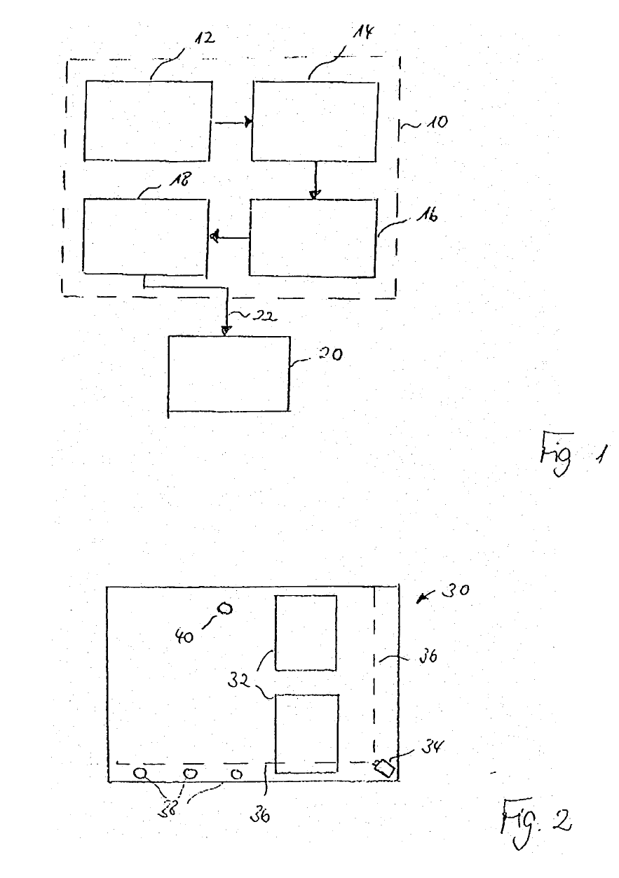

FIG. 1 is a functional block diagram of apparatus testing a fire sensing system of one illustrative embodiment of the present invention, and

FIG. 2 shows a test chamber, used in a method fo the invention, to simulate a test fire.

FIG. 1 is a functional block diagram of an illustrative embodiment of test apparatus 10 for a fire detection device, hereafter fire sensing system 20. In conventional operation, the fire sensing system 20 is connected to a video camera 34 (FIG. 2) taking a video picture of a closed room, for instance an aircraft cargo space. By analyzing the camera picture, for instance comparing it to a previously taken reference picture and determining the average of the gray values of the individual pixels and the associated standard deviation, the fire sensing system 20 decides whether fire broke out in the viewed space.

However the detection accuracy may be improved further by using highly developed algorithms. Illustrative the accuracy of detection is enhanced when the computation of the average and of the standard deviation is carried out not only once across the full camera picture, but separately for several non-overlapping partial zones of the camera picture.

To allow efficiently testing and analyzing different algorithms of this kind, the invention calls for simulating the pictures of the video camera 34 by means of the test apparatus 10.

The test apparatus 10 consists of a computer unit comprising an input device 12, a simulation device 14, a data processing device 16 and a replicating device 18.

FIG. 2 serves to elucidate the method of the invention and illustratively shows a test chamber denoted by the generic reference 30 and used to simulate a test fire 40. in the manner described below.

First, by manual operation or by retrieving a previously constituted file, the input device 12 receives the characteristic parameters of the video camera 34, of the test space 30 and of a test fire 40.

For this purpose the sensitivity, resolution and camera field of view are determined for the video camera 34. The test chamber of FIG. 2 is a model of an aircraft cargo space and for instance exhibits a rectangular floor 14.8 m long, 4.2 m wide and 1.7 m high.

The video camera 34 is mounted inside the space 30 in such manner to the ceiling that the field of view of 90°, shown in dashed lines, is subtended. The cargo space 30 moreover holds two containers 32 restricting the field of view of the camera 34 to a small narrow horizontal strip merely a few cm high. In this embodiment, and in order to detect a fire on account of rising smoke, three halogen lamps 38 are mounted outside the field of view 36 of the camera 34. Because of the masked field of view containing the three halogen lamps 38, no direct light may reach the video camera 34, only light that was reflected or scattered by smoke particles.

A fire 40 is simulated in the above test space at a position not in the direct field of view of the camera 34. The test-fire parameters in this illustrative implementation are selected in accordance with the European standard EN-54, for instance by simulating a TF4 test fire in which a polyurethane is burning with an open flame while generating billows of dark smoke.

Thereupon, and based on the characteristic parameters of the test chamber 30 and the fire 40, the simulating device 14 carries out digital flow simulation, in this embodiment a Large Eddy simulation (LES).

Thereupon the output data from the simulation device 14 are converted by the data processing device 16 into a format appropriate for the replication device 18.

By means of a visualization procedure, in this instance Raytracing, the replicating device 18 generates a photorealistic picture of the cargo space 30 including the fire 40 and the generated smoke. For that purpose and in manner known per se, a projection plane containing a number of pixels corresponding to the camera resolution is considered between the camera 34 and the virtual test chamber and a light beam is extended through each projection plane pixel into test space scene until it impacts an object. Due to the digital flow simulation of the fire 40, the fire, the flow of hot air and the rising smoke also constitute objects which may deflect or reflect the illumination from the halogen lamps 38. In this manner a realistic picture of the fire sequence in the cargo space is attained and is substituted for a genuine video picture from the fire sensing system 20 and will be analyzed further (reference 22).

Because computer-assisted simulation allows rapidly implementing a plurality of scenarios with different test space cargos and different kinds of fires, the present invention enables effectively testing and weighting the analytical algorithms used in the fire sensing system.

1. A method for testing a fire detecting device, hereafter fire sensing system, which, based on the pictures of an electro-optical camera, detects fires in enclosed spaces, said method comprising the procedural stages:
determining the characteristic parameters of the electro-optic camera,
determining characteristic parameters of a test space,
determining characteristic parameters of a test fire,
simulating the test-fire state in the test space on the basis of the test-space parameters and the test-fire parameters,
replicating an electro-optical camera picture on the basis of the camera parameters and the simulated test-fire state, and
feeding the replicated picture to the fire sensing system for purposes of fire analysis.

2. Method as claimed in claim 1, characterized in that the sensitivity and/or the resolution of the electro-optic camera are determined as characteristic parameters of said camera.

3. Method as claimed in either of claims 1 and 2, characterized in that the geometric structure of the test space and/or the loading of the test space with objects and/or the kind and position of illumination devices are determined as characteristic test-space parameters.

4. Method as claimed in one of the above claims, characterized in that the kind of fire and/or the burning material and/or the magnitude of the released heat of combustion and/or the kind and quantity of the generated smoke are determined as characteristic parameters of the test fire.

5. Method as claimed in one of the above claims, characterized by simulating the state of the test fire using a procedure of flow simulation, preferably the procedure of Large Eddy Simulation (LES).

6. Method as claimed in one of the above claims, characterized in that the electro-optic camera is a video camera and in that a camera picture is replicated by means of a visualization procedure, in particular the Raytracing procedure.

7. Method as claimed in one of the above claims, characterized in that the stages of simulating the test-fire state, of the replication of a picture of the electro-optic camera and of the transmission of the replicated picture to the fire sensing system are continuously repeated in time in order to feed the time function of the test fire to the fire sensing system for purposes of fire analysis.

8. An apparatus to implement the method for testing a fire sensing system as claimed in one of the above claims, comprising:
means (12) to determine the characteristic parameters of the electro-optic camera (34),
means (12) to determine characteristic parameters of a test chamber (30) and of a test fire (40),
a simulation device (14) to simulate the state of the test fire (40) in the test space (30) on the basis of the test-space parameters and the test-fire parameters,
a replication device (18) to replicate a picture of the electro-optical camera (34) on the basis of the camera parameters and the simulated state of the test fire (40) and
means to feed the replicated picture to the fire sensing system (20) for fire analysis.

9. Apparatus as claimed in claim 8, characterized in that the simulation device (14) and the replicating device (18) are integrated into a computer unit (10).
